(19) United States
(12) Patent Application Publication
(10) Pub. No.: US 2012/0089745 A1
(43) Pub. Date: Apr. 12, 2012

(54) COMPUTER ENABLED METHOD AND SYSTEM FOR ASSOCIATING AN IP ADDRESS TO A DOMAIN NAME

(76) Inventor: Bhavin Turakhia, Mumbai (IN)

(21) Appl. No.: 12/957,930

(22) Filed: Dec. 1, 2010

(30) Foreign Application Priority Data
Oct. 6, 2010 (IN) 2787/MUM/2010

(51) Int. Cl. G06F 15/16

(52) U.S. Cl. 709/245

(57) ABSTRACT

A computer enabled method and system for associating a source domain name to a source IP address in order to apply at least one rule to a user connecting from the source domain name and the source IP address is disclosed. The method includes receiving connections from one or more users associated with one or more domain names. The one or more users connect via one or more IP addresses. One or more running connection count rows comprising a count of connections received form a set of users within a predetermined time period and a unique IP address-domain name pair that is associated with the set of users is maintained. The method further includes selecting an IP address and a domain name from the one or more running connection count rows as the source IP address and the source domain name from a set of running connection count rows that contain the source IP address or the source domain name.

### FIELD OF THE INVENTION

The invention generally relates to managing access restrictions to one or more services for a set of users affiliated to an entity. More specifically, the invention relates to a computer enabled method and system for associating an Internet Protocol (IP) address to a domain name to configure access restrictions for the set of users to the one or more services.

### BACKGROUND OF THE INVENTION

Many organizations and institutions, today, use firewalls or inline network policies to monitor and control access of their employees to various third party websites and services. For instance, a Company may want to monitor/manage/govern the access rights and patterns of their employees to a service like Facebook, Microsoft Service Network (MSN) etc, as long as an employee is accessing the service from within the company network.

For example, the Company may wish to implement a simple rule that states that its employees who are working from within the Company premises should be not able to access the chat service provided by Facebook during work hours. Many such other rules or requirements can be perceived to be useful. Such as, all access to MSN messenger should be logged, only permit access to MSN between 6 pm and 8 pm, permit access to MSN, but only allow the users to chat with a predefined set of other users.

Some of the above requirements can be achieved by the Company by deploying a complicated firewall or inline network policy based on the service being accessed. The network admin of such a company may implement a firewall rule at the Company firewall, for instance, to block Facebook chat access for all employees.

However many enterprises do not have a network firewall or a network administrator to perform these types of tasks. Also many such rules are brittle, for instance, if MSN changes its IP address, or some such parameter used to create such a rule, then the rule may cease to function. Further, some rules cannot be created by such a mechanism. For instance, a rule that allows MSN access but only allows users to chat with a predefined list of other users. This rule cannot be implemented by a network admin with a simple firewall. Intimate details of the MSN protocol must be known and used to implement such a rule.

Therefore, there is a need for a method wherein the service provider directly provides such access rules and flexibility to the entity. MSN could, for instance, permit an administrator of an entity to specify that for any user who connects to MSN from that entity's office, a set of specific rules/access policies defined by the administrator must be applied.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an environment in which various embodiments of the present invention may function.

FIG. 2 illustrates a flow diagram of a computer enabled method for associating a source IP address to a source domain name in accordance with an embodiment of the present invention.

FIG. 3 illustrates a method for selecting a source IP address and a source domain name in accordance with an embodiment of the present invention.

FIG. 4 illustrates an exemplary depiction of a Table containing one or more running connection count rows in accordance with an embodiment of the present invention.

FIG. 5 illustrates a block diagram of a network enabled computer for associating a source IP address to a source domain name in accordance with an embodiment of the present invention.

FIG. 6 illustrates a block diagram of a system for associating a source IP address to a source domain name in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the present invention, it should be observed that the embodiments reside primarily in combinations of method steps and system components related to computer enabled method and system for associating a source IP address to a source domain name. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present invention provide a computer enabled method and system for linking a set of users to a particular entity so as to configure their access rights to third party services. The present invention proposes associating an IP address to a domain name such that access for any user connecting to a third party service through that IP address and domain name can be configured accordingly. An entity can be an organization, a company, an educational institution, etc.

Every user that accesses any network or web service from a device generally has at least two attributes. First is an identity containing an email address or a domain name that the user is affiliated to. For example, a user belonging to DirectI may have a directi.com email address associated with his profile. This domain name that a user is affiliated to is hereinafter referred to as source domain name. Those skilled in the art will appreciate that the source domain name that a user is associated with can be identified based on the user's email addresses.

Second is a public source IP address. Those skilled in the art will appreciate that the users within an entity connect to the Internet using the entity's internet connection. Each user may have a unique public IP Address or the user's machine may have an internal corporate Network Address Translated (NATed) IP address. If the user's machine is behind a NAT when the user accesses an external service on the Internet, his packets originate from the entity's public source IP address. If the user has a public IP address it can be assumed that most or all the users' within the entity share a common subnet. The public source IP address or the common subnet from where the user's connection originates is hereinafter referred to as source IP address. Thus, each connecting user is associated to a source domain name and a source IP address.

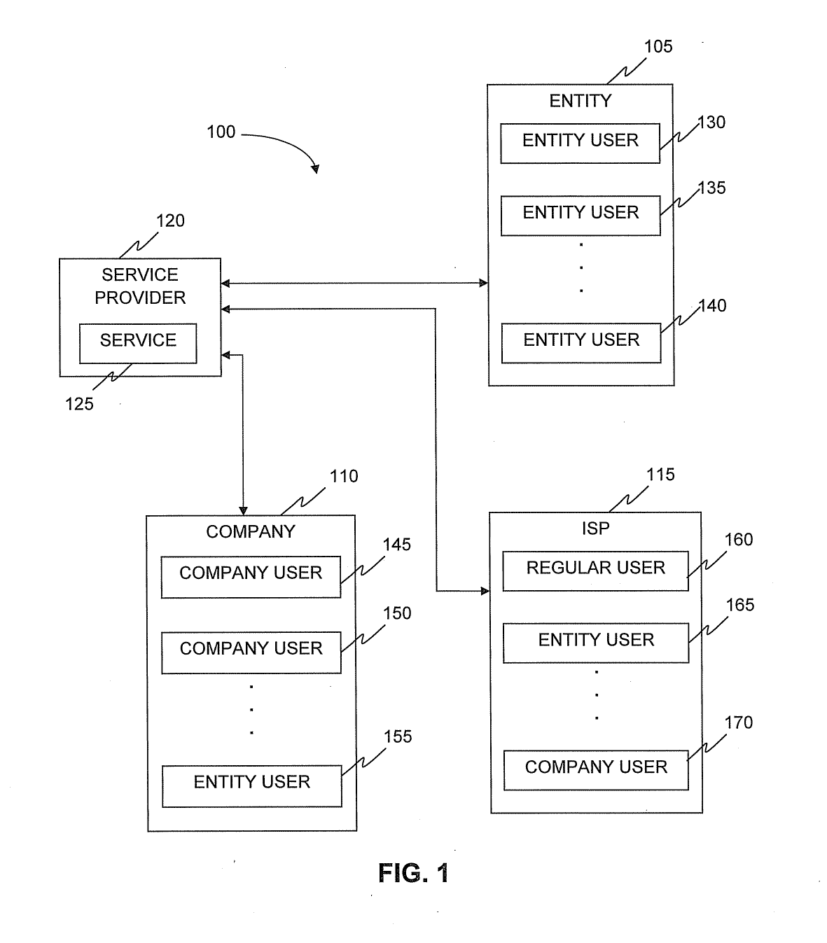

FIG. 1 illustrates a block diagram showing an environment 100 in which various embodiments of the present invention may function. Environment 100 comprises an Entity 105, a Company 110, an ISP 115 and a Service Provider 120. Service Provider 120 offers a Service 125 within Environment 100. Service Provider 120 can be, for instance, MSN, Yahoo, Facebook etc. and Service 125 can be any service provided by Service Provider 120 such as, but not limited to, a chat service, a social networking service, an application within a social network, an email service, and a blog service, video streaming etc.

Entity 105 and/or Company 110 can be a corporate company, an organization, an educational institution etc., and all such embodiments are within the scope of the present invention.

Entity 105 can have a plurality of employees, such as an Entity user 130 and an Entity user 135 as depicted in FIG. 1. Similarly, a Company user 145 and a Company user 150 are depicted as employees of Company 110. In accordance with the present exemplary embodiment, an Entity user 155 is an employee of Entity 105 who is working on the premises of Company 110 for a project.

A Regular user 150 may be connected to the internet through ISP 145. Regular user 150 can be any user who is not affiliated with either Entity 105 or Company 110. Also, an Entity user 155, who is an employee of Entity 105, and a Company user 160, who is an employee of Company 110, can be at home and connected to the internet via ISP 145.

In accordance with an embodiment of the present invention, Entity 105 may wish to apply a set of rules or access policies to all its employees who access Service 125 provided by Service Provider 120. Similarly Company 110 may wish to apply another set of rules or access policies to all its employees who access Service 125 provided by Service Provider 120.

For instance, Entity 105 may want Entity User 130, Entity User 135 and Entity User 140 to have no access to Service 125. Entity 105 may want Entity User 155 to have no access to Service 125 even though Entity User 155 is located at Company 110 premises and Entity User 165 to have full access to Service 125, since Entity User 125 is connected from his home.

For example, if Service Provider 120 is Google, and Service 125 is chat, then Entity 105 may want Entity User 130, Entity User 135, Entity User 140 and Entity User 155 to have no access to Google chat. Although, since Entity User 165 is at home and connected to Service Provider 120 via ISP 115, Entity 105 may not want to put any restrictions on access rights of Entity User 165.

Similarly, Company 110 may want Company User 145 and Company User 150 to have restricted access to Service 125. For instance, if Service 125 is Google chat, then Company 110 may want to allow its employees to exchange chat messages only with other employees of Company 110. However, Company 110 may not want restrict Company User 170 from accessing Google chat from home.

Various embodiments of the present invention enable Entity 105 and Company 110 to specify rules or access policies for one or more of its employees without using complicated firewalls. Service Provider 120 is configured to extract a domain name and an IP address from each user connection, associate a domain name with an IP address and determine a set of rules to be applied to a particular user connection.

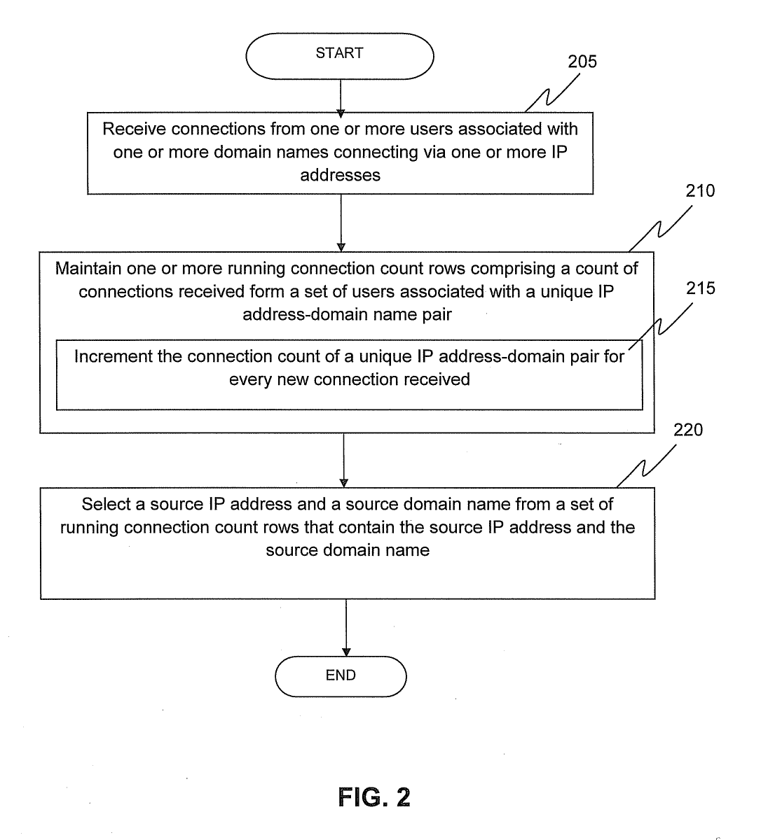

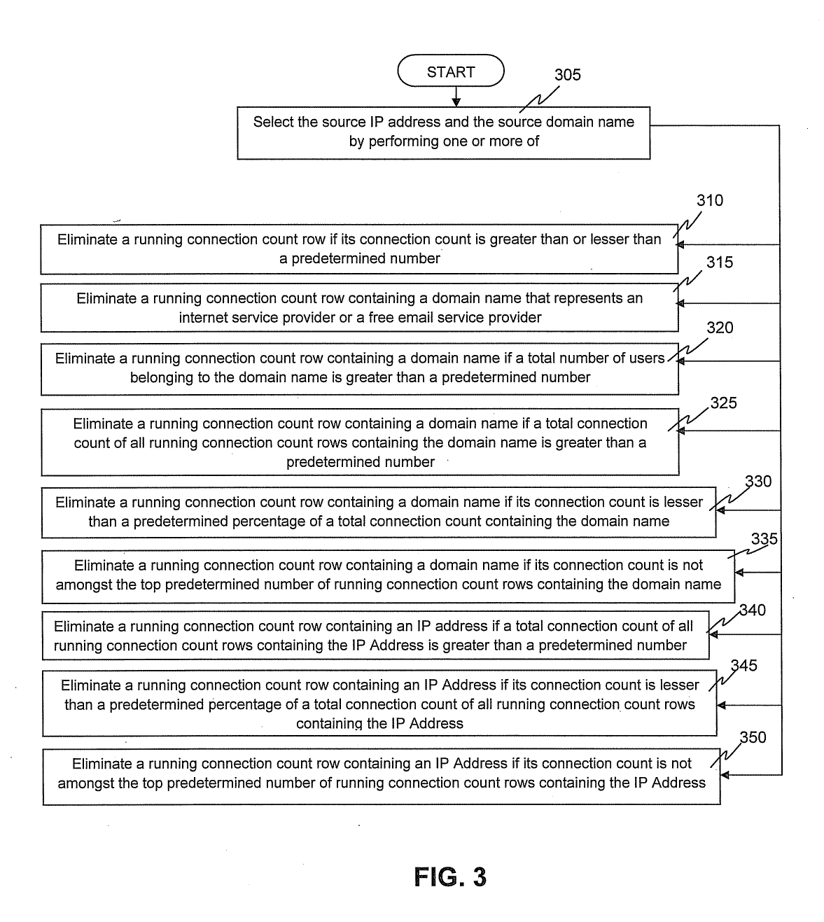

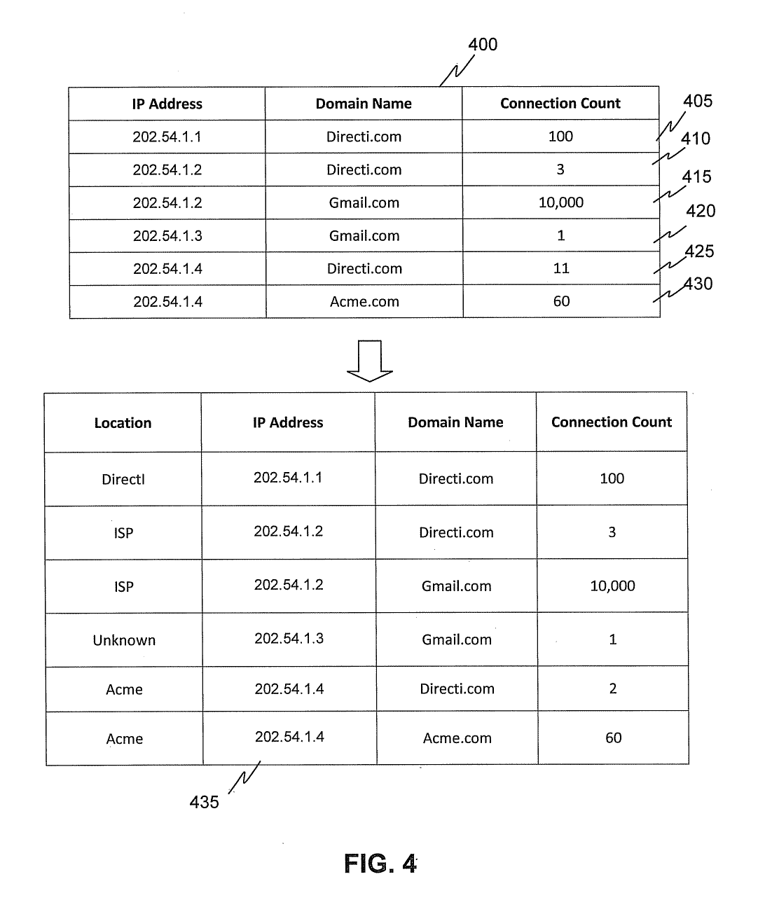

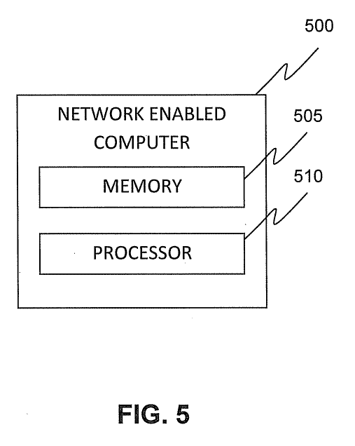

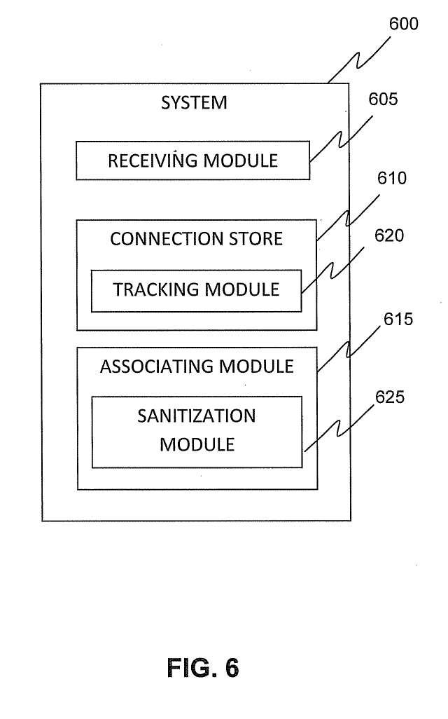

Method and system for managing access of one or more users to a service are described in detail in conjunction with FIG. 1, FIG. 2, FIG. 3, FIG. 4, FIG. 5 and FIG. 6 below.

Turning now to FIG. 2, a flow diagram of a computer enabled method for associating a source IP address to a source domain name is shown in accordance with an embodiment of the invention. As mentioned earlier, a user who connects to a service has a domain name associated with him. For instance, Entity User 130, Entity User 135, Entity User 140, Entity User 155 and Entity User 165 have an email address each under a domain name belonging to Entity 105. If Entity 105 is DirectI, then all employees of DirectI have an email address of the form user@directi.com.

This domain name that belongs to Entity 105 is hereinafter called source domain name. Hence, directi.com is the source domain name for all employees of DirectI.

Further, each user may connect to the Internet via a public IP address. As mentioned earlier, a user's machine may have an internal corporate NATed IP address. However, if the user's machine is behind a NAT when the user accesses an external service on the Internet, his packets originate from Entity's 105 public source IP address. The public source IP address from where the user's connection originates is hereinafter referred to as source IP address.

The computer enabled method of FIG. 2 enables a source domain name to be associated to a source IP address. Service Provider 120 applies a set of rules to connections originating from a unique pair of the source domain name and the source IP address.

The computer enabled method comprises receiving connections from one or more users via one or more IP addresses at step 205. As mentioned earlier, each user has an IP address-domain name pair associated with it.

At step 210, one or more running connection count rows are maintained. Each running connection count row comprises a count of connections received from a set of users associated with a unique IP address-domain name pair. In an embodiment of the present invention, the running connection count rows can be maintained at Service Provider 120.

For example, referring to FIG. 1, if Entity 105 is DirectI then employees of Entity 105 have a domain name directi.com associated with them. Further, if Entity 105 has a public IP address of 1.1.1.1, then each of Entity User 130, Entity User 135 and Entity User 140 have the IP address 1.1.1.1 associated with them. Thus, when Service Provider 120 receives a connection request from Entity User 130, Entity User 135 and Entity User 140, the one or more running connection count rows comprise the unique IP address-domain name pair of 1.1.1.1-directi.com, and a connection count of 3.

The running connection count rows are described in detail in conjunction with FIG. 4 below.

For maintaining the one or more running connection count rows at step 210, the connection count of a unique IP address-domain name pair is incremented, at step 215, for every new connection received from that IP address-domain name pair.

The source IP address and the source domain name is then selected, at step 220, from a set of running connection count rows that contain the source IP address or the source domain name. That is, if Service Provider 120 wants to associate an IP address with a domain name of Entity 105, then the source IP address and the source domain name are selected from all running connection count rows that contain the domain name of Entity 105. Similarly, if Service Provider 120 wants to associate a domain name with an IP address of Entity 105, then the source IP address and the source domain name are selected from all running connection count rows that contain the IP address of Entity 105. The selection of the source IP address and the source domain name is described in detail in conjunction with FIG. 4 below.

In one embodiment of the present invention, Service Provider 120 allows an administrator of the source domain name to specify at least one rule that is applicable to a user connecting from the source IP address. For example, Service Provider 120 may allow an administrator of Entity 105 to specify a rule that Entity user 130, Entity user 135 and Entity user 140 are not allowed to access Service 120 from an IP address of Entity 105.

The rule can be, but is not limited to, logging all data, allowing a connection, disallowing a connection, allowing or denying a user from accessing predetermined parts of Service 125 provided by Service Provider 120 or allowing or denying a user from interacting with only predetermined other users.

Referring now to FIG. 3, a method for selecting a source IP address and a source domain name is shown in accordance with an embodiment of the present invention. The source IP address and the source domain name is selected, at 305, from a set of running connection count rows that contain the source domain name and the source IP address by eliminating one or more running connection count rows. Criteria for eliminating the one or more running connection count rows are described below in detail.

In a first embodiment of the present invention, a running connection count row is eliminated, at step 310, if a connection count of the running connection count row is greater than or lesser than a predetermined number. In an embodiment of the present invention, the predetermined number can be specified by Service Provider 120. In another embodiment, the predetermined number can be provided by Entity 105 that wishes to provide its employees with restrictive access to Service 125.

For instance, if a connection count of a unique IP address-domain name pair is 10,000, then it can safely be assumed that the domain name in this unique IP address-domain name pair is a free email service provider's domain name, such as gmail.com etc, or the IP address belongs to an ISP and no restrictions need to be applied. In accordance with the exemplary embodiment depicted in FIG. 1, a running connection count row of unique IP address-domain name pair corresponding to an IP address of ISP 115 and a domain name of Regular User 160 can be eliminated, if its connection count is higher than a predetermined number, say 10,000.

Similarly, if a connection count of a unique IP address-domain name pair is lesser than a predetermined number, say 10, then that running connection count row can be eliminated.

In a second embodiment of the present invention, a running connection count row is eliminated, at step 315, if the running connection count row includes a domain name that represents an ISP or a free email service provider. Hence, in accordance with FIG. 1, any running connection count row containing an IP address of ISP 115 is eliminated. Further, any running connection count row containing a domain name belonging to a free email service provider, such as gmail.com, yahoo.com etc, is eliminated.

In a third embodiment of the present invention, a running connection count row is eliminated, at step 320, if the total number of users associated with a domain name in the running connection count row is greater than a predetermined number. For instance, Service Provider 120 may receive more than 10,000 connections from users who have a same domain name associated with them. Such running connection count rows are eliminated in accordance with this embodiment.

In a fourth embodiment of the present invention, a running connection count row is eliminated, at step 325, if a connection count of all running connection count rows that include the domain name is greater than a predetermined number. For instance, there may be more than one running connection count rows that include a free email service provider domain name such as gmail.com, yahoo.com etc. If a sum of connection counts of all such running connection count rows is greater than a predetermined number, specified by Service Provider 120 or an entity, then all such running connection count rows are eliminated at step 325.

In a fifth embodiment of the present invention, a running connection count row containing a domain name is eliminated, at step 330, if a connection count of the running connection count row is lesser than a predetermined percentage of the total connection count of all running connection count rows containing that domain name. For instance, if a connection count of a running connection count row containing DirectI.com is lesser than 10% of the total connection count of all running connection count rows containing the domain name DirectI.com, then the running connection count row is eliminated. This embodiment enables Entity 105 to exclude those employees from access restrictions who are accessing Service 125 from home, etc.

In a sixth embodiment of the present invention, a running connection count row containing a domain name is eliminated, at step 335, if a connection count of the running connection count row is not amongst the top predetermined number of running connection count rows containing that domain name. For instance, if a running connection count row containing DirectI.com has a connection count of 10, and is not amongst the top 3 connection counts of running connection count rows containing DirectI.com, then the running connection count row is eliminated at step 335.

In a seventh embodiment of the present invention, a running connection count row containing an IP address is eliminated, at step 340, if a total connection count of all running connection count rows containing that IP address is greater than a predetermined number. This ensures that any user connecting from an ISP is excluded from restricted access of Service 125.

In an eighth embodiment of the present invention, a running connection count row containing an IP address is eliminated, at step 345, if its connection count is lesser than a predetermined percentage of a total connection count of all running connection count rows containing that IP address. This embodiment enables Entity 105 to exclude those employees from access restrictions who are accessing Service 125 from home or unknown locations.

In a ninth embodiment of the present invention, a running connection count row containing an IP address is eliminated, at step 350, if its connection count is not amongst the top predetermined number of running connection count rows containing that IP address. For instance, if a running connection count row containing an IP address 202.54.1.2. and has a connection count of 3, and is not the top connection counts of running connection count rows containing the IP address 202.54.1.2., then the running connection count row is eliminated at step 350.

Each of the eliminating steps, step 310, step 315, step 320, step 325, step 330, step 335, step 340, step 345 and step 350 can be applied in a combination of one or more as preferred by Entity 105 that wishes to restrict access of Service 125 for its employees.

Also, the eliminating steps, step 310, step 315, step 320, step 325, step 330, step 335, step 340, step 345 and step 350 can be performed one or more times to finally associate the source IP address to the source domain name.

Referring now to FIG. 4, an exemplary depiction of a Table 400 containing one or more running connection count rows is shown in accordance with an embodiment of the present invention. Table 400 comprises a running connection count row 405, a running connection count row 410, a running connection count row 415, a running connection count row 420, a running connection count row 425 and a running connection count row 430. Each running connection count row corresponds to a unique IP address-domain name pair. In accordance with an embodiment of the present invention, Table 400 can be maintained at Service Provider 120.

Each running connection count row comprises an IP address, a domain name and a connection count corresponding to the number of users connecting from that unique IP address-domain name pair. Connection count of a running connection count row is incremented whenever a new connection is received from a unique IP address-domain name pair corresponding to that running connection count row.

Table 400 comprising the one or more running connection count rows is sanitized to select a source IP address and a source domain name. The method of selecting the source IP address associated with the source domain name is explained in detail in conjunction with FIG. 3 above.

In conjunction with FIG. 4 and step 310 of FIG. 3, running connection count row 415 can be eliminated if connection count of 10,000 is greater than the predetermined number set by Service Provider 120 or an entity. Similarly, running connection count row 410 and running connection count row 420 can be eliminated if connection count of 3 is lesser than the predetermined number set by Service Provider 120 or an entity.

In conjunction with FIG. 4 and step 315 of FIG. 3, running connection count row 415 and running connection count row 420 can be eliminated since Service Provider 120 recognizes Gmail.com as a free email service provider. Hence, no access restrictions are applied to users that have Gmail.com associated with them. Similarly, if Service Provider 120 already knows that the IP address 202.54.1.2 belongs to ISP 115, then running connection count row 410 and running connection count row 415 may also be eliminated.

In conjunction with FIG. 4 and step 320 of FIG. 3, running connection count row 415 and running connection count row 420 are eliminated if more than a predetermined number of connections are received from Gmail.com in a particular interval of time.

In conjunction with FIG. 4 and step 325 of FIG. 3, running connection count row 415 and running connection count row 420 containing Gmail.com are eliminated, if their total connection count, in this case 10,001, is greater than the a predetermined number. Total connection count of all running connection count rows containing DirectI.com is 114, and Acme.com is 60. This may not be greater than the predetermined number and, hence, running connection count row 405, running connection count row 410, running connection count row 425 and running connection count row 430 are not eliminated in accordance with step 325.

In conjunction with FIG. 4 and step 330 of FIG. 3, running connection count row 410, running connection count row 420 and running connection count row 425 can be eliminated if their connection counts constitute to lesser than a predetermined percentage of the total connection counts. Running connection count row 405, running connection count row 415 and running connection count row 430 are not eliminated. Those skilled in the art will realize that step 330 can be repeated on a set of running connection count rows that are not eliminated in the first iteration, and numerous such iterations can be till a desired IP address source-domain name pair remains.

In conjunction with FIG. 4 and step 335 of FIG. 3, running connection count row 410 can be eliminated since its connection count is not amongst the top predetermined number, for instance top 2, of running connection count rows containing the domain name DirectI.com. Similarly, running connection count row 420 can be eliminated since its connection count is not amongst the top predetermined number, say 1, of running connection count rows containing the domain name Gmail.com. Running connection count row 430 may not be eliminated since Table 400 has only one running connection count row containing the domain name Acme.com.

In conjunction with FIG. 4 and step 340 of FIG. 3, running connection count row 410 and running connection count row 415 can be eliminated since total connection counts of all running connection count rows containing the IP address 202.54.1.2 is 10,001, which is greater than a predetermined number, say 1000, set by Service Provider 120.

In conjunction with FIG. 4 and step 345 of FIG. 3, the running connection count row 410 is eliminated since its connection count, 3, may be lesser than a predetermined percentage of a total connection count of all running connection count rows containing the IP address 202.54.1.2, in this case the total connection count is 10,003.

In conjunction with FIG. 4 and step 345 of FIG. 3, the running connection count row 410 may be eliminated, since its connection count, 3, may not be amongst the top predetermined number of running connection count rows containing the IP address 202.54.1.2.

As mentioned earlier in conjunction with FIG. 3 above, one or more of the eliminating steps can be applied to Table 400, in any perceivable order and any number of times to get the source domain name and the source IP address. Those skilled in the art will realize that more eliminating steps of the nature described above can be applied and all such embodiments are within the scope of the present invention.

Those skilled in the art will realize that one or more of eliminating step 310, eliminating step 315, eliminating step 310, eliminating step 320, eliminating step 325, eliminating step 335, eliminating step 345 and eliminating step 350 along with eliminating step 330 results in eliminating running connection count row 410, running connection count row 415, running connection count row 420 and running connection count row 425 from Table 400.

After sanitizing Table 400, in an embodiment of the present invention, Service Provider 120 can assume that an IP address is associated with a domain name if the IP address and the domain name belong to only one running connection count row in Table 400.

In another embodiment of the present invention, Service Provider 120 can assume that an IP address is associated with one or more domain names if the connection count of a running connection count row containing the IP address and a domain name is such that its connection count constitutes greater than a predetermined percentage of the total connection count of all running connection count rows containing the domain name.

In yet another embodiment of the present invention, Service Provider 120 assumes that an IP address is associated with one or more domain names if the connection count of a running connection count row containing the IP address and a domain name is such that the connection count constitutes greater than a predetermined percentage of the total connection count of all running connection count rows containing that IP address.

In another embodiment of the present invention, Service Provider 120 assumes that an IP address is associated with one or more domain names if the connection count of a running connection count rows containing the IP address and a domain name is such that the connection count is amongst a top predetermined number of connection counts across all running connection count rows containing that domain name.

In another embodiment of the present invention, Service Provider 120 assumes that an IP address is associated with one or more domain names if the connection count of a running connection count row containing the IP address and a domain name is such that the connection count is amongst a top predetermined number of connection counts across all running connection count rows containing that IP address.

Those skilled in the art will appreciate that the predetermined percentages and the predetermined numbers mentioned above can be fixed or dynamic, can depend on the total number of users from a domain name, or the total number of users connected from an IP address, or historical data, or a combination thereof.

In accordance with FIG. 4, the resultant source domain name and source IP address includes the unique IP address-domain name pair of running connection count row 405 and running connection count row 430. Thus, Service Provider 120 can determine that a source domain name DirectI.com is associated with a source IP address 202.54.1.1 and a source domain name Acme.com is associated with a source IP address 202.54.1.4. Further, since running connection count row 415 has a connection count of more than a predetermined number, Service Provider 120 may identify the IP address 202.54.1.2 to belong to an ISP. These associations determined by Service Provider 120 are depicted in a Table 435.

In accordance with the present invention, an administrator of the domain name DirectI.com can inform Service Provider 120 to apply a set of rules to all users connecting from its office premises. Service Provider 120 then determines the IP address associated with DirectI based on the method disclosed above, and applies the set of rules to all users associated with that unique domain name-IP address pair.

Those skilled in the art will realize that the present invention also allows an entity such as DirectI to define a different set of rules for its employees working from Acme premises. Many such embodiments are foreseen and are within the scope of the present invention.

Referring now to FIG. 5, a block diagram of a network enabled computer 500 for associating a source IP address to a source domain name is shown in accordance with an embodiment of the present invention. Network enabled computer 500 comprises a Memory 505 and a Processor 510. Processor 510 associates the source IP address to a source domain name, so that a set of access rules can be applied to users connecting from a unique pair of the source domain name and the source IP address.

For associating the source IP address to the source domain name, Processor 510 is configured to receive connections from one or more users via one or more IP addresses. As mentioned earlier, each of the one or more users has a domain name associated with it. Thus, it may be assumed that a connection from each user has an IP address-domain name pair associated with it.

Processor 510 in conjunction with Memory 505 is further configured to maintain one or more running connection count rows. Each running connection count row comprises a count of connections received from a set of users associated with a unique IP address-domain name pair. Those skilled in the art will appreciate that the running connection count rows can be maintained at Service Provider 120 providing Service 125 to users.

The running connection count rows are explained in detail in conjunction with FIG. 4 above.

For maintaining the one or more running connection count rows, Processor 510 is configured to increment the connection count of a unique IP address-domain name pair, for every new connection received from that IP address-domain name pair.

Processor 510 then selects the source IP address and the source domain name from a set of running connection count rows that contain the source IP address or the source domain name. That is, if Service Provider 120 wants to associate an IP address with a domain name of Entity 105, then the source IP address and the source domain name are selected from all running connection count rows that contain the domain name of Entity 105. Similarly, if Service Provider 120 wants to associate a domain name with an IP address of Entity 105, then the source IP address and the source domain name are selected from all running connection count rows that contain the IP address of Entity 105. The selection of the source IP address and the source domain name is described in detail in conjunction with FIG. 4 above.

For selecting the source domain name and the source IP address, in an embodiment of the present invention, Processor 510 is further configured to eliminate running connection count row if the connection count of the row is greater than or lesser than a predetermined number. This embodiment is described in detail in conjunction with FIG. 3 and FIG. 4 above.

In another embodiment of the present invention, Processor 510 is configured to eliminate a running connection count row containing a domain name that represents one or more of an ISP or a free email service provider. This embodiment is described in detail in conjunction with FIG. 3 and FIG. 4 above.

In another embodiment of the present invention, Processor 510 is configured to eliminate a running connection count row containing a domain name if a total number of users belonging to the domain name is greater than a predetermined number. This embodiment is described in detail in conjunction with FIG. 3 and FIG. 4 above.

In another embodiment of the present invention, Processor 510 is configured to eliminate a running connection count row containing a domain name if a total connection count of all running connection count rows containing the domain name is greater than a predetermined number. This embodiment is described in detail in conjunction with FIG. 3 and FIG. 4 above.

In another embodiment of the present invention, Processor 510 is configured to eliminate a running connection count row containing a domain name if its connection count is not amongst the top predetermined number of running connection count rows containing the domain name. This embodiment is described in detail in conjunction with FIG. 3 and FIG. 4 above.

In another embodiment of the present invention, Processor 510 is configured to eliminate a running connection count row containing an IP address if a total connection count of all running connection count rows containing the IP address is greater than a predetermined number. This embodiment is described in detail in conjunction with FIG. 3 and FIG. 4 above.

In another embodiment of the present invention, Processor 510 is configured to eliminate a running connection count row containing an IP address its connection count is lesser than a predetermined percentage of a total connection count of all running connection count rows containing the IP address. This embodiment is described in detail in conjunction with FIG. 3 and FIG. 4 above.

In another embodiment of the present invention, Processor 510 is configured to eliminate a running connection count row containing an IP address if its connection count is not amongst the top predetermined number of running connection count rows containing the IP address. This embodiment is described in detail in conjunction with FIG. 3 and FIG. 4 above.

In another embodiment of the present invention, Processor 510 is configured to eliminate a running connection count row containing an IP address, if its connection count is lesser than a predetermined percentage of a total connection count of all running connection count rows containing that IP address. This embodiment is described in detail in conjunction with FIG. 3 and FIG. 4 above.

In another embodiment of the present invention, Processor 510 is configured to eliminate a running connection count row containing an IP address, if its connection count is not amongst the top predetermined number of running connection count rows containing that IP address. This embodiment is described in detail in conjunction with FIG. 3 and FIG. 4 above.

Those skilled in the art will realize that Processor 510 can perform the above embodiments one or more times for selecting the source IP address and the source domain name.

Upon associating the source IP address to the source domain name, Service provider 120 may allow an administrator of the source domain name to specify at least one rule that is applicable to one or more users connecting from the source IP address and the source domain name.

Those skilled in the art will appreciate that, Network enabled computer 500 may be operationally coupled to Service Provider 120. Network enabled computer 500 may also entirely, or in part reside between Service Provider 120 and an entity and all such embodiments are within the scope of the present invention.

Referring now to FIG. 6 a block diagram of a System 600 for associating a source IP address to a source domain name is shown in accordance with an embodiment of the present invention. System 600 comprises a Receiving Module 605 for receiving connections from one or more users associated with one or more domain names. As mentioned earlier, in addition to a domain name, each user also has an IP address associated with him, via which he connects to the Internet.

System 600 further comprises a Connection Store 610. Connection Store 610 is configured to maintain one or more running connection count rows, wherein each running connection count row contains a unique IP address-domain name pair and a count of connections received form a set of users associated with the unique IP address-domain name pair within a predetermined time period.

System 600 comprises an Associating Module 615, which is configured to select an IP address and a domain name as the source IP address and the source domain name. Essentially, the source IP address and the source domain name are selected from a set of running connection count rows that contain the source IP address or the source domain name.

To ensure that the running connection count rows are updated, Connection Store 610 further comprises a Tracking Module 620. Tracking Module 620 is configured to increment the connection count of a unique IP address-domain name pair for every new connection received from a user associated with that unique IP address-domain name pair.

For selecting the source domain name and the source IP address from a set of running connection count rows, Associating Module 615 further comprises a Sanitization Module 625. Sanitization Module 625 can perform one or more eliminating steps on the set of running connection count rows to filter out running connection count rows for which no rule may need to be applied.

For instance, in an embodiment of the present invention, Sanitization Module 625 is configured to eliminate a running connection count row if its connection count is greater than a predetermined number or lesser than a predetermined number. This embodiment is described in detail in conjunction with FIG. 3 and FIG. 4 above.

In another embodiment of the present invention, Sanitization Module 625 is configured to eliminate a running connection count row containing a domain name that represents one or more of an Internet Service Provider and a free email service provider. This embodiment is described in detail in conjunction with FIG. 3 and FIG. 4 above.

In another embodiment of the present invention, Sanitization Module 625 is configured to eliminate a running connection count row containing a domain name if a total number of users associated to the domain name is greater than a predetermined number. This embodiment is described in detail in conjunction with FIG. 3 and FIG. 4 above.

In another embodiment of the present invention, Sanitization Module 625 is configured to eliminate a running connection count row containing a domain name if a total connection count of all running connection count rows containing the domain name is greater than a predetermined number. This embodiment is described in detail in conjunction with FIG. 3 and FIG. 4 above.

In another embodiment of the present invention, Sanitization Module 625 is configured to eliminate a running connection count row containing a domain name if its connection count is lesser than a predetermined percentage of a total connection count of all running connection count rows containing the domain name. This embodiment is described in detail in conjunction with FIG. 3 and FIG. 4 above.

In another embodiment of the present invention, Sanitization Module 625 is configured to eliminate a running connection count row containing a domain name if its connection count is not amongst the top predetermined number of running connection count rows containing the domain name. This embodiment is described in detail in conjunction with FIG. 3 and FIG. 4 above.

In another embodiment of the present invention, Sanitization Module 625 is configured to eliminate a running connection count row containing an IP Address if a total connection count of all running connection count rows containing the IP Address is greater than a predetermined number. This embodiment is described in detail in conjunction with FIG. 3 and FIG. 4 above.

In another embodiment of the present invention, Sanitization Module 625 is configured to eliminate a running connection count row containing an IP Address if its connection count is lesser than a predetermined percentage of a total connection count of all running connection count rows containing the IP Address. This embodiment is described in detail in conjunction with FIG. 3 and FIG. 4 above.

In another embodiment of the present invention, Sanitization Module 625 is configured to eliminate a running connection count row containing an IP Address where its connection count is not amongst the top predetermined number of running connection count rows containing the IP Address. This embodiment is described in detail in conjunction with FIG. 3 and FIG. 4 above.

In another embodiment of the present invention, Sanitization Module 625 is configured to eliminate a running connection count row containing an IP address, if its connection count is lesser than a predetermined percentage of a total connection count of all running connection count rows containing that IP address. This embodiment is described in detail in conjunction with FIG. 3 and FIG. 4 above.

In another embodiment of the present invention, Sanitization Module 625 is configured to eliminate a running connection count row containing an IP address, if its connection count is not amongst the top predetermined number of running connection count rows containing that IP address. This embodiment is described in detail in conjunction with FIG. 3 and FIG. 4 above.

In an embodiment of the present invention, Association Module 615 is deployed on a server at Service Provider 120 providing services such as, but not limited to, a chat service, a social networking service, an application within a social network, an email service, and a blog service. In another embodiment, Association Module 615 is deployed on an external device that is operatively coupled to Service Provider 120.

Service Provider 120 may allow an administrator of the source domain name to specify at least one rule that is applicable to at least one user connecting from the source IP address. This enables Service Provider 120 to provide a customized access to its Service 125 for users of an entity. Service Provider 120 may render Service 125 to another company with a different set of rules applied, as specified by the company.

Various embodiments of the invention provide computer enabled method and systems for associating a source domain name to a source IP address. The method and system enables an entity to specify access rules for one or more services provided by a Service Provider, such that the access rules are applied to any employee connecting to the Service Provider from the premises of the Entity, without the need of a firewall. The present invention also allows for an Entity to specify rules for its employees connecting to the Service Provider from IP addresses other than the Entity's IP address.

The method for associating a source domain name to a source IP address, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method of the invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A computer enabled method for associating a source IP address to a source domain name, the method comprising:
receiving connections from one or more users associated with one or more domain names, the source domain name being one of the one or more domain names, the one or more users connecting via one or more IP addresses, the source IP address being one of the one or more IP addresses;
maintaining one or more running connection count rows, each running connection count row comprising a count of connections received from a set of users within a predetermined time period, the set of users being associated with a unique IP address-domain name pair, the unique IP address-domain name pair comprising a domain name from the one or more domain names and an IP address from one or more IP addresses; and
selecting an IP address and a domain name as the source IP address and the source domain name from a set of running connection count rows comprising one or more of the source IP address and the source domain name for associating the source IP address to the source domain name, the selecting step comprising performing one or more of:
eliminating a running connection count row if the connection count of the running connection count row is one or more of greater than and lesser than a predetermined number,
eliminating a running connection count row containing a domain name that represents one or more of an interne service provider and a free email service provider,
eliminating a running connection count row containing a domain name if a total number of users associated to the domain name is greater than a predetermined number,
eliminating a running connection count row containing a domain name if a total connection count of all running connection count rows containing the domain name is greater than a predetermined number,
eliminating a running connection count row containing a domain name if the connection count of the running connection count row is lesser than a predetermined percentage of a total connection count of all running connection count rows containing the domain name,
eliminating a running connection count row containing a domain name if the connection count of the running connection count row is not amongst the top predetermined number of running connection count rows containing the domain name,
eliminating a running connection count row containing an IP Address if a total connection count of all running connection count rows containing the IP Address is greater than a predetermined number,
eliminating a running connection count row containing an IP Address if a connection count of the running connection count row is lesser than a predetermined percentage of a total connection count of all running connection count rows containing the IP Address; and
eliminating a running connection count row containing an IP Address if a connection count of the running connection count row is not amongst the top predetermined number of running connection count rows containing the EP Address.

2. The computer enabled method of claim 1, wherein the maintaining step further comprises:
incrementing the connection count of a unique IP address-domain name pair for every new connection received from a user belonging to a domain name connecting via an IP address, the domain name and the IP address corresponding to the unique IP address-domain name pair.

3. The computer enabled method of claim 1, wherein the one or more eliminating steps are performed one or more times for selecting the source IP address and the source domain name.

4. The computer enabled method of claim 1, wherein the running connection count rows are maintained at a service provider providing a service.

5. The computer enabled method of claim 4, wherein the service is one or more of a chat service, a social networking service, an application within a social network, an email service, and a blog service.

6. The computer enabled method of claim 1, wherein a service provider allows an administrator of the source domain name to specify at least one rule that is applicable to at least one user connecting from the source IP address.

7. The computer enabled method of claim 6, wherein the at least one rule is one or more of logging all data, allowing a connection, disallowing a connection, allowing or denying the at least one user from accessing predetermined parts of a service provided by the service provider and allowing or denying the at least one user from interacting with only predetermined other users.

8. The computer enabled method of claim 1, wherein a domain name that a user is associated with is identified based on a user's email address.

9. A networked enabled computer comprising:
a memory; and
a processor associating a source IP address to a source domain name, the process configured to:
receive connections from one or more users associated with one or more domain names, the source domain name being one of the one or more domain names, the one or more users connecting via one or more IP addresses, the source IP address being one of the one or more IP addresses;
maintain one or more running connection count rows, each running connection count row comprising a count of connections received form a set of users within a predetermined time period, the set of users being associated with a unique IP address-domain name pair, the unique IP address-domain name pair comprising a domain name from the one or more domain names and an IP address from one or more IP addresses; and
select an IP address and a domain name as the source IP address and the source domain name from a set of running connection count rows containing one or more of the source IP address and the source domain name for associating the source IP address to the source domain name, the processor further configured to perform one or more of:
eliminate a running connection count row if the connection count of the running connection count row is one or more of greater than and lesser than a predetermined number,
eliminate a running connection count row containing a domain name that represents one or more of an internet service provider and a free email service provider,
eliminate a running connection count row containing a domain name if a total number of users associated to the domain name is greater than a predetermined number,
eliminate a running connection count row containing a domain name if a total connection count of all running connection count rows containing the domain name is greater than a predetermined number,
eliminate a running connection count row containing a domain name if the connection count of the running connection count row is lesser than a predetermined percentage of a total connection count of all running connection count rows containing the domain name,
eliminate a running connection count row containing a domain name if the connection count of the running connection count row is not amongst the top predetermined number of running connection count rows containing the domain name,
eliminate a running connection count row containing an IP Address if a total connection count of all running connection count rows containing the IP Address is greater than a predetermined number,
eliminate a running connection count row containing an IP Address if the connection count of a running connection count row containing the IP Address is lesser than a predetermined percentage of a total connection count of all running connection count rows containing the IP Address; and
eliminate a running connection count row containing an IP Address where the connection count of the running connection count row containing the source IP Address is not amongst the top predetermined number of running connection count rows containing the IP Address.

10. The network enabled computer of claim 9, wherein the network enabled computer belongs to a service provider.

11. The network enabled computer of claim 9, wherein the processor performs the one or more eliminating steps one or more times for selecting the source IP address and the source domain name.

12. The network enabled computer of claim 9, wherein a service provider allows an administrator of the source domain name to specify at least one rule that is applicable to at least one user connecting from the source IP address.

13. A system for associating a source IP address to a source domain name, the system comprising:
a receiving module, the receiving module receiving connections from one or more users associated with one or more domain names, the source domain name being one of the one or more domain names, the one or more users connecting via one or more IP addresses, the source IP address being one of the one or more IP addresses;
a connection store, the connection store configured to maintain one or more running connection count rows, each running connection count row comprising a count of connections received form a set of users within a predetermined time period, the set of users being associated with a unique IP address-domain name pair, the unique IP address-domain name pair comprising a domain name from the one or more domain names and an IP address from one or more IP addresses; and
an associating module, the associating module configured to select an IP address and a domain name as the source IP address and the source domain name from a set of running connection count rows containing one or more of the source IP address and the source domain name, the associating module further comprises a sanitization module, the sanitization module configured to:
eliminate a running connection count row if the connection count of the running connection count row is one or more of greater than and lesser than a predetermined number,
eliminate a running connection count row containing a domain name that represents one or more of an internet service provider and a free email service provider,
eliminate a running connection count row containing a domain name if a total number of users associated to the domain name is greater than a predetermined number,
eliminate a running connection count row containing a domain name if a total connection count of all running connection count rows containing the domain name is greater than a predetermined number,
eliminate a running connection count row containing a domain name if the connection count of the running connection count row is lesser than a predetermined percentage of a total connection count of all running connection count rows containing the domain name,
eliminate a running connection count row containing a domain name if the connection count of the running connection count row is not amongst the top predetermined number of running connection count rows containing the domain name,
eliminate a running connection count row containing an IP Address if a total connection count of all running connection count rows containing the IP Address is greater than a predetermined number,
eliminate a running connection count row containing an IP Address if the connection count of a running connection count row containing the IP Address is lesser than a predetermined percentage of a total connection count of all running connection count rows containing the IP Address; and
eliminate a running connection count row containing an IP Address where the connection count of the running connection count row containing the source IP Address is not amongst the top predetermined number of running connection count rows containing the IP Address.

14. The system of claim 13, wherein the connection store further comprises a tracking module, the tracking module configured to increment the connection count of a unique IP address-domain name pair for every new connection received from a user associated with a domain name connecting via an IP address, the domain name and the IP address corresponding to the unique IP address-domain name pair.

15. The system of claim 13, wherein the association module is deployed on a server at a service provider providing a service.

16. The system of claim 15, wherein the service is one or more of a chat service, a social networking service, an application within a social network, an email service, and a blog service.

17. The system of claim 13, wherein a service provider allows an administrator of the source domain name to specify at least one rule that is applicable to at least one user connecting from the source IP address.
